(19) United States
(12) Patent Application Publication
(10) Pub. No.: US 2011/0273578 A1
(43) Pub. Date: Nov. 10, 2011

(54) ELECTRONIC CAMERA

(75) Inventor: Masayoshi Okamoto, Daito-shi (JP)

(73) Assignee: SANYO ELECTRIC CO., LTD., Osaka (JP)

(21) Appl. No.: 13/089,858

(22) Filed: Apr. 19, 2011

(30) Foreign Application Priority Data
May 10, 2010 (JP) 2010-107861

(51) Int. Cl. H04N 5/228

(52) U.S. Cl. 348/222.1; 348/E05.031

(57) ABSTRACT

An electronic camera includes an imager. An imager repeatedly outputs an image representing a scene captured on an imaging surface. A first searcher searches for a face image representing a face portion of a person from the image outputted from the imager. A designator designates an animal-face dictionary corresponding to a posture along a posture of the face image discovered by the first searcher from among a plurality of animal-face dictionaries respectively corresponding to a plurality of postures different from one another. A second searcher executes a process of searching for a face image representing a face portion of an animal from the image outputted from the imager by referring to the animal-face dictionary designated by the designator. A processor executes an output process different depending on a search result of the second searcher.

### CROSS REFERENCE OF RELATED APPLICATION

The disclosure of Japanese Patent Application No. 2010-107861, which was filed on May 10, 2010, is incorporated herein by reference.

### BACKGROUND OF THE INVENTION

1. Field of the Invention

The present invention relates to an electronic camera. More particularly, the present invention relates to an electronic camera which searches for a specific object image from a scene image.

2. Description of the Related Art

According to one example of this type of camera, when a face of a person is included in a subject indicated by digital image information acquired by an imaging section, a detecting section detects a position and a size of a face region in the subject. A specifying section specifies whether a vertical photographing composition or a horizontal photographing composition is set. When the position of the face region detected by the detecting section exists within a predetermined range including a center of the subject in a horizontal direction, the size of the face region detected by the detecting section is equal to or more than a predetermined size and concurrently, the specifying section specifies a horizontal photographing composition, a control section controls to display information recommending the vertical photographing composition.

However, in the above-described camera, when an animal widely different in its face characteristic depending upon each family and species is photographed, a load of a determining process for a posture of the animal on an imaging surface is increased, and therefore, an imaging performance is limited in this regard.

### SUMMARY OF THE INVENTION

An electronic camera according to the present invention, comprises: an imager which repeatedly outputs an image representing a scene captured on an imaging surface; a first searcher which searches for a face image representing a face portion of a person from the image outputted from the imager; a designator which designates an animal-face dictionary corresponding to a posture along a posture of the face image discovered by the first searcher from among a plurality of animal-face dictionaries respectively corresponding to a plurality of postures different from one another; a second searcher which executes a process of searching for a face image representing a face portion of an animal from the image outputted from the imager by referring to the animal-face dictionary designated by the designator; and a processor which executes an output process different depending on a search result of the second searcher.

According to the present invention, a computer program embodied in a tangible medium, which is executed by a processor of an electronic camera provided with an imager which repeatedly outputs an image representing a scene captured by an imaging surface, comprises: a first searching instruction to search for a face image representing a face portion of a person from the image outputted from the imager; a designating instruction to designate an animal-face dictionary corresponding to a posture along a posture of the face image discovered by the first searching instruction from among a plurality of animal-face dictionaries respectively corresponding to a plurality of postures different from one another; a second searching instruction to execute a process of searching for a face image representing a face portion of an animal from the image outputted from the imager by referring to the animal-face dictionary designated based on the designating instruction; and a processing instruction to execute an output process different depending on a search result of the second searching instruction.

According to the present invention, an imaging control method executed by an electronic camera provided with an imager which repeatedly outputs an image representing a scene captured on an imaging surface, the imaging control method comprises: a first searching step of searching for a face image representing a face portion of a person from the image outputted from the imager; a designating step of designating an animal-face dictionary corresponding to a posture along a posture of the face image discovered by the first searching step from among a plurality of animal-face dictionaries respectively corresponding to a plurality of postures different from one another; a second searching step of executing a process of searching for a face image representing a face portion of an animal from the image outputted from the imager by referring to the animal-face dictionary designated by the designating step; and a processing step of executing an output process different depending on a search result of the second searching step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a state where an evaluation area is allocated to an imaging surface;

FIG. 4 is an illustrative view showing one example of a register referred to in a pet imaging task;

FIG. 5 is an illustrative view showing one example of a characteristic amount of a face of a person contained in a person dictionary HDC;

FIG. 6 is an illustrative view showing one example of a face-detection frame structure used in the pet imaging task;

FIG. 7 is an illustrative view showing one portion of a face detection process in the pet imaging task;

FIG. 8 is an illustrative view showing one example of an image representing a person captured by the imaging surface;

FIG. 9 is an illustrative view showing one example of another register referred to in the pet imaging task;

FIG. 10 is an illustrative view showing one example of a configuration of a pet dictionary PDC;

FIG. 11 is an illustrative view showing one example of a characteristic amount of a face of an animal contained in the pet dictionary PDC;

FIG. 12 is an illustrative view showing one example of an image representing an animal captured by the imaging surface;

FIG. 13 is an illustrative view showing one example of each of the images of the person and the animal captured by the imaging surface;

FIG. 14 is a flowchart showing one portion of behavior of a CPU applied to the embodiment in FIG. 2;

FIG. 15 is a flowchart showing another portion of behavior of the CPU applied to the embodiment in FIG. 2;

FIG. 16 is a flowchart showing still another portion of behavior of the CPU applied to the embodiment in FIG. 2;

FIG. 17 is a flowchart showing yet another portion of behavior of the CPU applied to the embodiment in FIG. 2;

FIG. 18 is a flowchart showing another portion of behavior of the CPU applied to the embodiment in FIG. 2;

FIG. 19 is a flowchart showing still another portion of behavior of the CPU applied to the embodiment in FIG. 2;

FIG. 20 is a flowchart showing yet another portion of behavior of the CPU applied to the embodiment in FIG. 2;

FIG. 21 is a flowchart showing another portion of behavior of the CPU applied to the embodiment in FIG. 2;

FIG. 22 is a flowchart showing still another portion of behavior of the CPU applied to the embodiment in FIG. 2; and

FIG. 23 is a flowchart showing yet another portion of behavior of the CPU applied to the embodiment in FIG. 2.

### DETAILED DESCRIPTION OF THE PREFERRED EMBODIMENTS

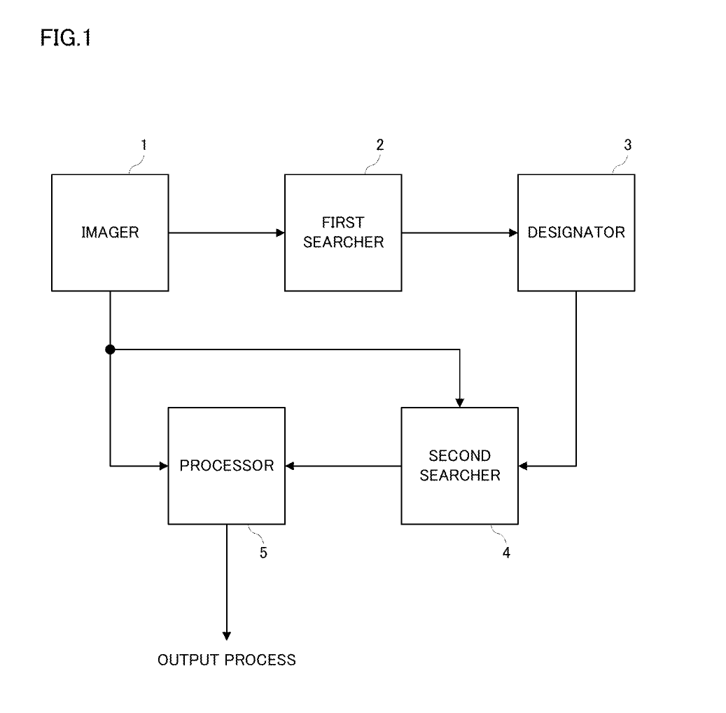

With reference to FIG. 1, an electronic camera of one embodiment of the present invention is basically configured as follows: An imager 1 repeatedly outputs an image representing a scene captured on an imaging surface. A first searcher 2 searches for a face image representing a face portion of a person from the image outputted from the imager 1. A designator 3 designates an animal-face dictionary corresponding to a posture along a posture of the face image discovered by the first searcher 2 from among a plurality of animal-face dictionaries respectively corresponding to a plurality of postures different from one another. A second searcher 4 executes a process of searching for a face image representing a face portion of an animal from the image outputted from the imager 1 by referring to the animal-face dictionary designated by the designator 3. A processor 5 executes an output process different depending on a search result of the second searcher 4.

Thus, upon searching for the face image representing the face portion of the animal, out of the plurality of animal-face dictionaries respectively corresponding to the plurality of postures different from one another, an animal-face dictionary corresponding to the posture along the posture of the face image representing the face portion of the person is referred to. Thereby, a time period required for searching for the face image of the animal is shortened, and as a result, an imaging performance is improved.

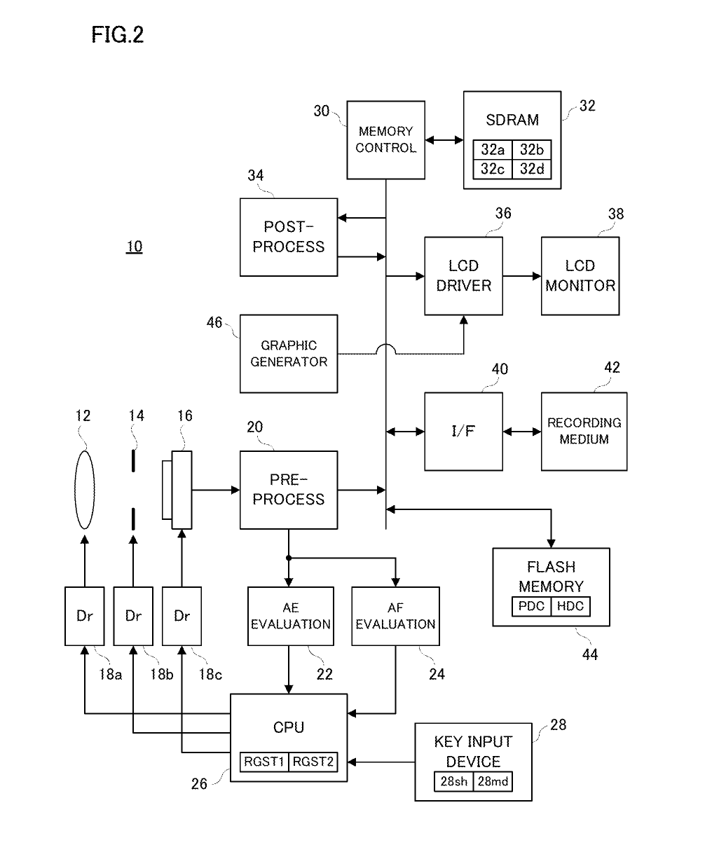

With reference to FIG. 2, a digital camera 10 according to one embodiment includes a focus lens 12 and an aperture unit 14 driven by drivers 18a and 18b, respectively. An optical image of the scene that underwent these components enters, with irradiation, the imaging surface of an imager 16, and is subjected to a photoelectric conversion. Thereby, electric charges representing the scene image are produced.

When a normal imaging mode or a pet imaging mode is selected by a mode key 28md arranged in a key input device 28, a CPU 26 commands a driver 18c to repeat exposure behavior and electric-charge reading-out behavior in order to start a moving-image taking process under the normal imaging task or the pet imaging task. In response to a vertical synchronization signal Vsync periodically generated from an SG (Signal Generator) not shown, the driver 18c exposes the imaging surface and reads out the electric charges produced on the imaging surface in a raster scanning manner. From the imager 16, raw image data that is based on the read-out electric charges is cyclically outputted.

A pre-processing circuit 20 performs processes, such as digital clamp, pixel defect correction, gain control and etc., on the raw image data outputted from the imager 16. The raw image data on which these processes are performed is written into a raw image area 32a of an SDRAM 32 through a memory control circuit 30.

A post-processing circuit 34 reads out the raw image data accommodated in the raw image area 32a through the memory control circuit 30, performs processes such as a color separation process, a white balance adjusting process, a YUV converting process and etc., on the read-out raw image data, and individually creates display image data and search image data that comply with a YUV format.

The display image data is written into a display image area 32b of the SDRAM 32 by the memory control circuit 30. The search image data is written into a search image area 32c of the SDRAM 32 by the memory control circuit 30.

An LCD driver 36 repeatedly reads out the display image data accommodated in the display image area 32b through the memory control circuit 30, and drives an LCD monitor 38 based on the read-out image data. As a result, a real-time moving image (the live view image) of the scene is displayed on a monitor screen. It is noted that a process on the search image data will be described later.

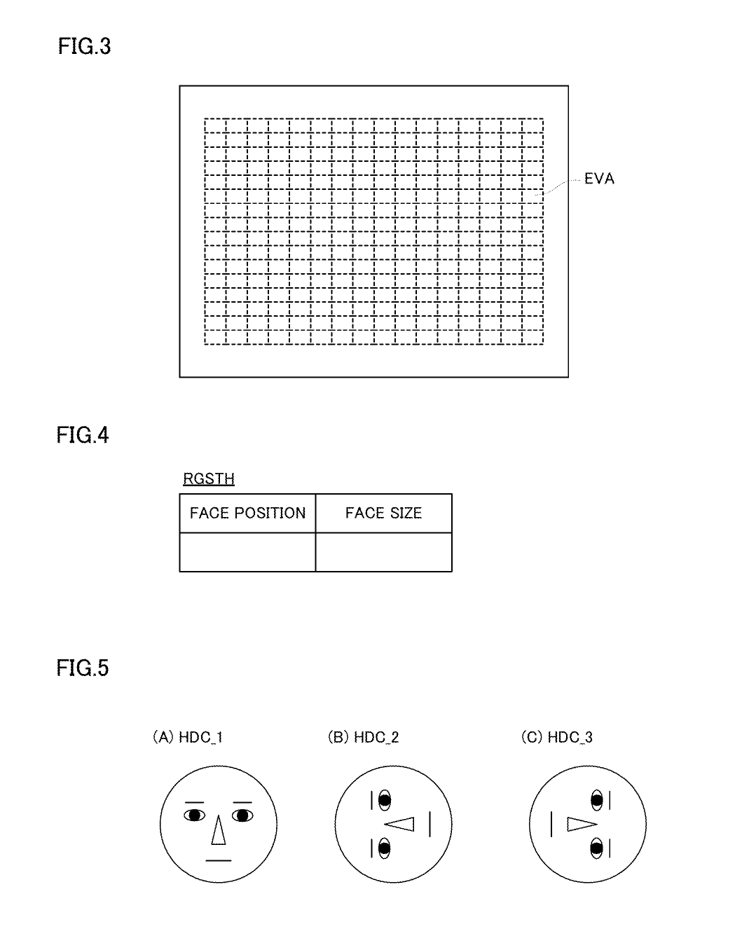

With reference to FIG. 3, an evaluation area EVA is allocated to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 20 executes a simple RGB converting process for simply converting the raw image data into RGB data.

An AE evaluating circuit 22 integrates, out of the RGB data produced by the pre-processing circuit 20, RGB data belonging to the evaluation area EVA every time the vertical synchronization signal Vsync is generated. Thereby, 256 integral values (256 AE evaluation values) are outputted from the AE evaluating circuit 22 in response to the vertical synchronization signal Vsync.

Moreover, an AF evaluating circuit 24 extracts, out of the RGB data outputted from the pre-processing circuit 20, a high-frequency component of the RGB data belonging to the same evaluation area EVA and integrates the extracted high-frequency component every time the vertical synchronization signal Vsync is generated. Thereby, 256 integral values (256 AF evaluation values) are outputted from the AF evaluating circuit 24 in response to the vertical synchronization signal Vsync.

The CPU 26 executes, in parallel with a moving-image taking process, a simple AE process that is based on the output from the AE evaluating circuit 22 so as to calculate an appropriate EV value. An aperture amount and an exposure time period that define the calculated appropriate EV value are set to the drivers 18b and 18c, respectively. As a result, a brightness of the live view image is adjusted approximately.

When a shutter button 28sh is half-depressed in a state where the normal imaging mode is selected, the CPU 26 executes an AE process that is based on the output of the AE evaluating circuit 22 under the normal imaging task and sets the aperture amount and the exposure time period that define an optimal EV value calculated thereby to the drivers 18b and 18c, respectively. As a result, the brightness of the live view image is adjusted strictly. Moreover, the CPU 26 executes an AF process that is based on the output from the AF evaluating circuit 24 under the normal imaging task so as to set the focus lens 12 to a focal point through the driver 18a. Thereby, a sharpness of the live view image is improved.

When the shutter button 28sh is shifted from a half-depressed state to a fully-depressed state, the CPU 26 starts up an I/F 40, for a recording process, under the normal imaging task. The I/F 40 reads out one frame of the display image data representing the scene at a time point at which the shutter button 28sh is fully depressed, from the display image area 32b through the memory control circuit 30, and records an image file in which the read-out display image data is contained onto a recording medium 42.

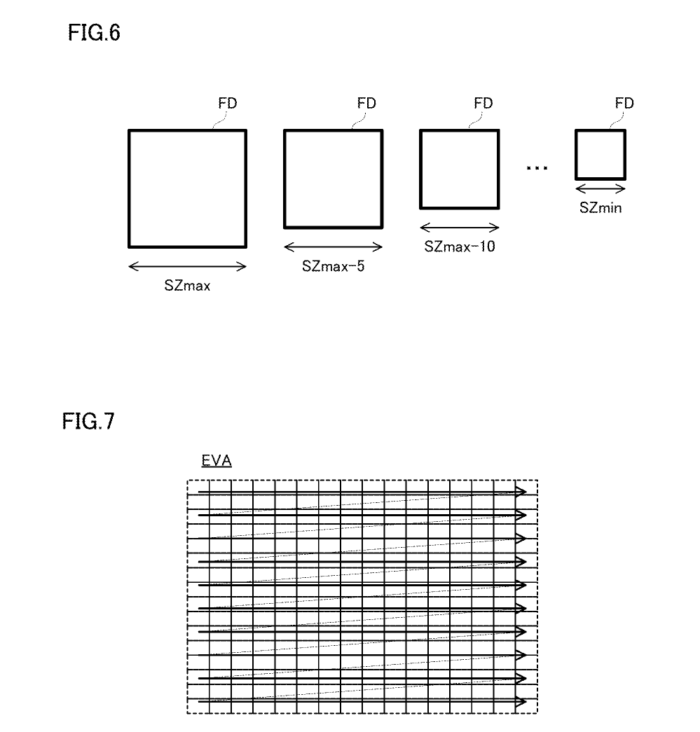

When the pet imaging mode is selected, under a person-face detecting task executed in parallel with the pet imaging task, the CPU 26 searches for the face image of the person from the image data accommodated in the search image area 32c. For the person-face detecting task, a register RGSTH shown in FIG. 4, a person dictionary HDC shown in FIG. 5 (A) to FIG. 5 (C), and a plurality of face-detection frame structures FD, FD, FD, . . . shown in FIG. 6 are prepared.

The register RGSTH is equivalent to a register used for holding face-image information of the person, and is formed by a column in which a position of the detected face image of the person (a position of the face-detection frame structure FD at a time point at which the face image is detected) is described and a column in which a size of the detected face image (a size of the face-detection frame structure FD at a time point at which the face image is detected) is described.

In the person dictionary HDC, three characteristic amounts respectively corresponding to three face postures of the person are accommodated. An example of FIG. 5 (A) corresponds to an upright posture of the person and is allocated to a face-pattern number HDC_1. An example of FIG. 5 (B) corresponds to a posture of the person inclined by 90 degrees to a left and is allocated to a face-pattern number HDC_2. An example of FIG. 5 (C) corresponds to a posture of the person inclined by 90 degrees to a right and is allocated to a face-pattern number HDC_3.

The face-detection frame structure FD shown in FIG. 6 moves in a raster scanning manner on a search area allocated to the search image area 32c. The size of the face-detection frame structure FD is reduced by a scale of “5” from a maximum size SZmax to a minimum size SZmin every time the raster scanning is ended.

Firstly, the search area is set so as to cover the whole evaluation area EVA. Moreover, the maximum size SZmax is set to “200”, and the minimum size SZmin is set to “20”. Therefore, the face-detection frame structure FD, having the size which changes in ranges “200” to “20”, is scanned on the evaluation area EVA as shown in FIG. 7.

Under the person-face detecting task, firstly, a flag FLG_H_END is set to “0”. Here, the flag FLG_H_END is a flag for identifying whether or not the person-face detecting task is completed. “0” indicates the task being under execution while “1” indicates the task being completed.

When the vertical synchronization signal Vsync is generated, image data belonging to the face-detection frame structure FD is read out from the search image area 32c so as to calculate a characteristic amount of the read-out image data.

Firstly, a variable HDIR is set to “0”. Subsequently, a variable N is set to each of “1”, “2”, and “3” so as to compare the calculated characteristic amount with a face pattern HDC_N contained in the person dictionary HDC. As described above, the three characteristic amounts respectively corresponding to the three face postures of the person are contained in the person dictionary HDC, and the variable N corresponds to the posture of the person. Thus, the characteristic amount of the image data read out from the search image area 32c is compared with the three characteristic amounts.

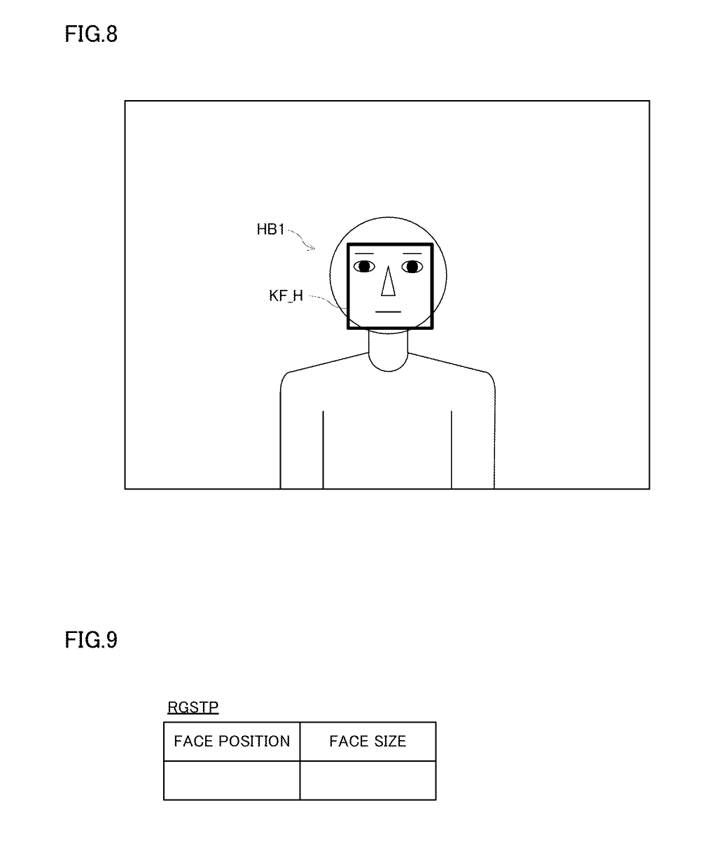

On the assumption that a face of a person HB1 standing upright is captured as shown in FIG. 8, a matching degree to a characteristic amount of a face pattern allocated to the face pattern number HDC_1 exceeds a reference value H_REF when the face of the person HB1 is captured in a posture of a camera housing standing upright. Moreover, a matching degree to a characteristic amount of a face pattern allocated to the face pattern number HDC_2 exceeds the reference value H_REF when the face of the person HB1 is captured in a posture of a camera housing inclined by 90 degrees to the right. Furthermore, a matching degree to a characteristic amount of a face pattern allocated to the face pattern number HDC_3 exceeds the reference value H_REF when the face of the person HB1 is captured in a posture of a camera housing inclined by 90 degrees to the left.

When the matching degree exceeds the reference value H_REF, the CPU 26 regards the face of the person HB1 as being discovered, registers a position and a size of the face-detection frame structure FD at a current time point as the face-image information on the register RGSTH, and concurrently, sets the variable HDIR to a value in which the variable N indicates at a current time point. That is, since the variable N corresponds to the posture of the person HB1, posture information of the discovered person HB1 is held by the variable HDIR. Furthermore, in response thereto, the flag FLG_H_END is set to “1” so as to complete the person-face detecting task

The variable HDIR is set to “0” as an initial setting under the person-face detecting task, and is updated to the value in which the variable N indicates when a face image coincident with the characteristic amount of the face of the person contained in the person dictionary HDC is discovered. Thereby, it is indicated that the face image of the person is discovered when the variable HDIR is other than “0”.

When the flag FLG_H_END is updated to “1” and the variable HDIR is other than “0” which is an initial value, the CPU 26 issues a face-frame-structure character display command corresponding to the position and size of the face-detection frame structure FD at a current time point toward a graphic generator 46. Moreover, the graphic generator 46 creates graphic image data representing a face frame structure based on the applied face-frame-structure character display command, and applies the created graphic image data to the LCD driver 36. The LCD driver 36 displays, based on the applied graphic image data, a face-frame-structure character KF_H on the LCD monitor 38 in a manner to surround the face image of the person HB1 (see FIG. 8).

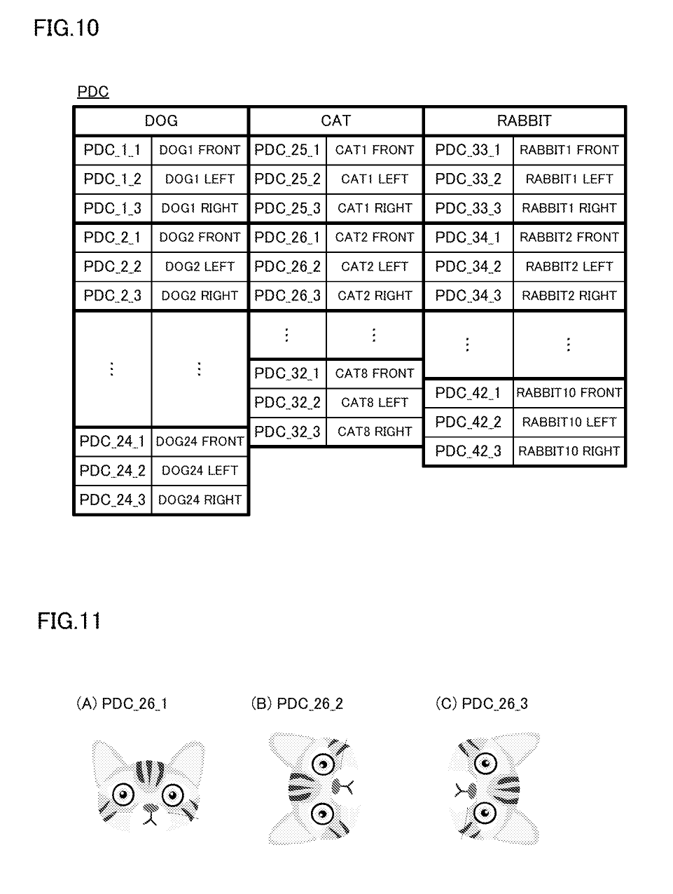

When the pet imaging mode is selected, under a pet-face detecting task executed after completion of the person-face detecting task in parallel with the pet imaging task, the CPU 26 searches for the face image of the animal from the image data accommodated in the search image area 32c. For the pet-face detecting task, a register RGSTP shown in FIG. 9 and a pet dictionary PDC shown in FIG. 10 are prepared.

The register RGSTP shown in FIG. 9 is equivalent to a register used for holding face-image information of the animal, and is formed by a column in which a position of the detected face image of the animal (a position of the face-detection frame structure FD at a time point at which the face image is detected) is described and a column in which a size of the detected face image (a size of the face-detection frame structure FD at a time point at which the face image is detected) is described.

In the pet dictionary PDC shown in FIG. 10, characteristic amounts of faces of animals of 42 species are respectively allocated to face pattern numbers PDC_1_1 to PDC_42_3. Characteristic amounts of faces of dogs of 24 species are respectively allocated to the face pattern numbers PDC_1_1 to PDC_24_3, characteristic amounts of faces of cats of 8 species are respectively allocated to the face pattern numbers PDC_25_1 to PDC_32_3, and characteristic amounts of faces of rabbits of 10 species are respectively allocated to the face pattern numbers PDC_33_1 to PDC_42_3. It is noted that, in an example of FIG. 10, a character string composed of the family name, the number and the posture is allocated to each of the face pattern numbers PDC_1_1 to PDC_42_3, however, in reality, the characteristic amount of the face of the animal is allocated.

Moreover, three characteristic amounts respectively corresponding to three postures are contained in the pet dictionary PDC for each species. An example of FIG. 11 (A) corresponds to an upright posture of a cat 2 and is allocated to a face-pattern number PDC_26_1. An example of FIG. 11 (B) corresponds to a posture of the cat 2 inclined by 90 degrees to a left and is allocated to a face-pattern number PDC_26_2. An example of FIG. 11 (C) corresponds to a posture of the cat 2 inclined by 90 degrees to a right and is allocated to a face-pattern number PDC_26_3. Similarly, a characteristic amount of a face of each species in an upright posture is allocated to a face pattern number PDC_L_1 (L=1, 2, 3 . . . 42), a characteristic amount of a face of each species in a posture inclined by 90 degrees to the left is allocated to a face pattern number PDC_L_2, and a characteristic amount of a face of each species in a posture inclined by 90 degrees to the right is allocated to a face pattern number PDC_L_3.

Thus, when the face pattern number in the pet dictionary PDC is represented as “PDC_L_M” (L=1, 2, 3 . . . 42, M=1, 2, 3), a variable L corresponds to the species of the animal, and a variable M corresponds to the posture.

Upon completion of the person-face detecting task, the pet-face detecting task is started up. Under the pet-face detecting task, firstly, a flag FLG_P_END is set to “0”. Here, the flag FLG_P_END is a flag for identifying whether or not the pet-face detecting task is completed. “0” indicates the task being under execution while “1” indicates the task being completed.

When the vertical synchronization signal Vsync is generated, the image data belonging to the face-detection frame structure FD is read out from the search image area 32c so as to calculate the characteristic amount of the read-out image data. Subsequently, a flag FLG_P_DTCT is set to “0”. The flag FLG_P_DTCT is a flag for identifying whether or not a characteristic amount in which a matching degree to the image data belonging to the face-detection frame structure FD exceeds a reference value P_REF is discovered in the pet dictionary PDC. “0” indicates being undiscovered while “1” indicates being discovered.

As described above, it is indicated that the face image of the person is discovered when the variable HDIR is other than “0”. Therefore, the face image of the person is undiscovered when the variable HDIR is “0”. In this case, under the pet-face detecting task, the calculated characteristic amount is compared with all of the characteristic amounts contained in the pet dictionary PDC.

Specifically, the variable L is set to each of “1”, “2”, “3” to “42” and the variable M is set to each of “1”, “2” and “3” so as to compare the calculated characteristic amount with a characteristic amount of the face pattern number PDC_L_M in the pet dictionary PDC. As described above, the three characteristic amounts respectively corresponding to the three face postures are contained in each of 42 species in the pet dictionary PDC. Thus, the calculated characteristic amount is compared with a total of 126 characteristic amounts (42 species×3 postures).

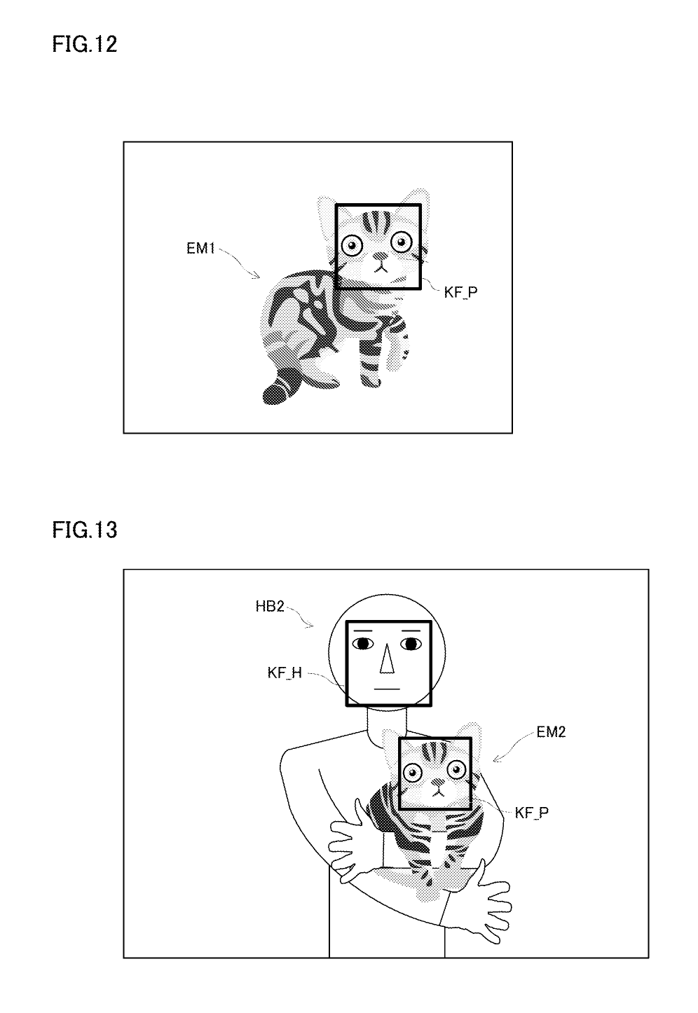

With reference to FIG. 12, in a case where a cat EM1 whose species is a cat 2 is captured on the imaging surface, on the assumption that the face of the cat EM1 stands upright, a matching degree to the characteristic amount of the face pattern allocated to the face pattern number PDC_26_1 exceeds the reference value P_REF when the face of the cat EM1 is captured in the posture of the camera housing standing upright. Moreover, a matching degree to the characteristic amount of the face pattern allocated to the face pattern number PDC_26_2 exceeds the reference value P_REF when the face of the cat EM1 is captured in the posture of the camera housing inclined by 90 degrees to the right. Furthermore, a matching degree to the characteristic amount of the face pattern allocated to the face pattern number PDC_26_3 exceeds the reference value P_REF when the face of the cat EM1 is captured in the posture of the camera housing inclined by 90 degrees to the left.

When the matching degree exceeds the reference value P_REF, the CPU 26 regards the face of the animal as being discovered, registers the position and size of the face-detection frame structure FD at a current time point as the face-image information on the register RGSTP, and concurrently, updates the flag FLG_P_DTCT to “1”. Furthermore, in response thereto, the flag FLG_P_END is set to “1” so as to complete the pet-face detecting task.

When the flag FLG_P_END is updated to “1” and the flag FLG_P_DTCT is “1”, the CPU 26 issues the face-frame-structure character display command corresponding to the position and size of the face-detection frame structure FD at a current time point toward the graphic generator 46. The graphic generator 46 creates graphic image data representing the face frame structure based on the applied face-frame-structure character display command, and applies the created graphic image data to the LCD driver 36. The LCD driver 36 displays, based on the applied graphic image data, a face-frame-structure character KF_P on the LCD monitor 38 in a manner to surround the face image of the cat EM1 (see FIG. 12).

On the other hand, when the variable HDIR is other than “0”, that is, when the face image of the person is discovered, under the pet-face detecting task, the image data belonging to the face-detection frame structure FD is compared with a partial characteristic amount contained in the pet dictionary PDC.

As shown in FIG. 13, when the person and the animal are captured on the imaging surface simultaneously, both of their face postures are often the same. Therefore, when the posture (the inclination of the camera housing) is ascertained as a result of the face of the person being detected in the person-face detecting task, under the pet-face detecting task, a comparing process is performed with reference to only a characteristic amount corresponding to a posture identical with a posture of the person, out of the characteristic amounts of the faces of the animals contained in the pet dictionary PDC. Thereby, the time period required for searching for the face image of the animal is shortened.

Specifically, when the characteristic amount of the face pattern number PDC_L_M is used for the comparing process, the variable L is set to each of “1”, “2”, “3” to “42” while the variable M is set to the value indicated by the variable HDIR holding the posture information of the person. Thus, the characteristic amount of the image data belonging to the face-detection frame structure FD is compared with 42 characteristic amounts (=42 species×one posture) out of 126 characteristic amounts contained in the pet dictionary PDC.

According to an example of FIG. 13, a face of a person HB2 stands upright on the assumption that the scene is captured in a state of the camera housing standing upright, and therefore, a matching degree of a face image of the person HB2 to the characteristic amount of the face pattern number HDC_1 exceeds the reference value HREF. Therefore, the variables N and HDIR are set to “1”, and then, under the pet-face detecting task, the characteristic amount of the image data belonging to the face-detection frame structure is compared with the characteristic amount of the face pattern number PDC_L_1 (L=1, 2, 3 . . . 42) in the pet dictionary PDC.

When the species of a cat EM2 held by the person HB2 in his arms is “cat 2”, the characteristic amount of the face pattern number PDC_261 exceeds the reference value P_REF, and concurrently, the face-image information is registered on the register RGSTP.

Since a face image of the cat EM2 is discovered, the flag FLG_P_DTCT is updated to “1”, and upon completion of the pet-face detecting task, the face-frame-structure character KF_P is displayed together with the face-frame-structure character KF_H on the LCD monitor 38 (see FIG. 13).

Thereafter, under the pet imaging task, the CPU 26 executes a strict AE process and an AF process in which the discovered face image of the cat EM2 is noticed. One frame of the image data immediately after the AF process is completed is taken by a still-image taking process into a still-image area 32d. The taken one frame of the image data is read out from the still-image area 32d by the I/F 40 which is started up in association with the recording process, and is recorded on the recording medium 42 in a file format Upon completion of the recording process, the face-frame-structures KF_H and KF_P are hidden.

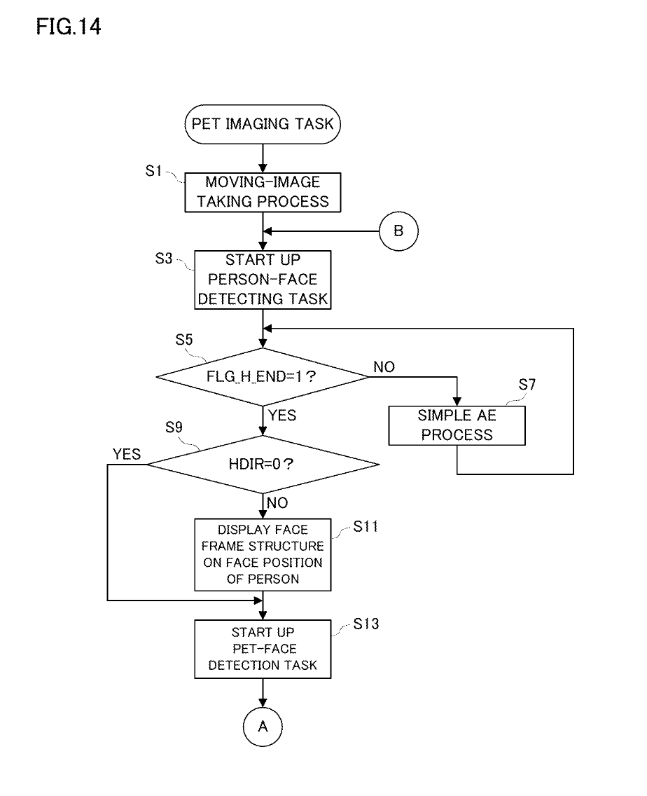

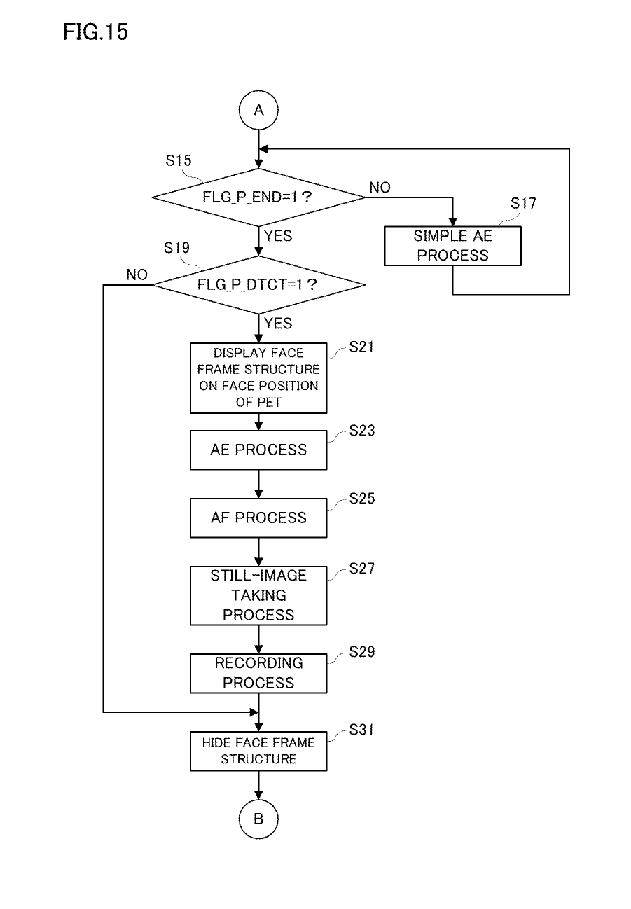

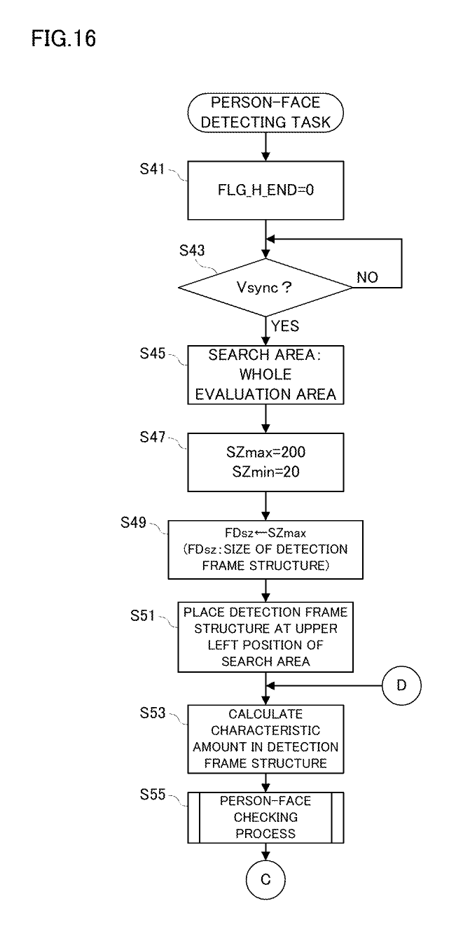

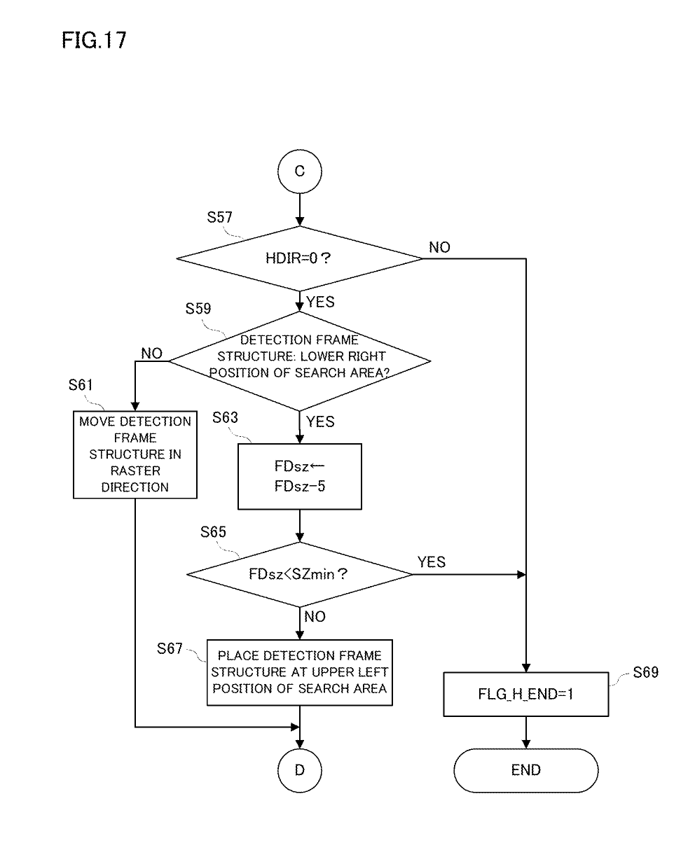

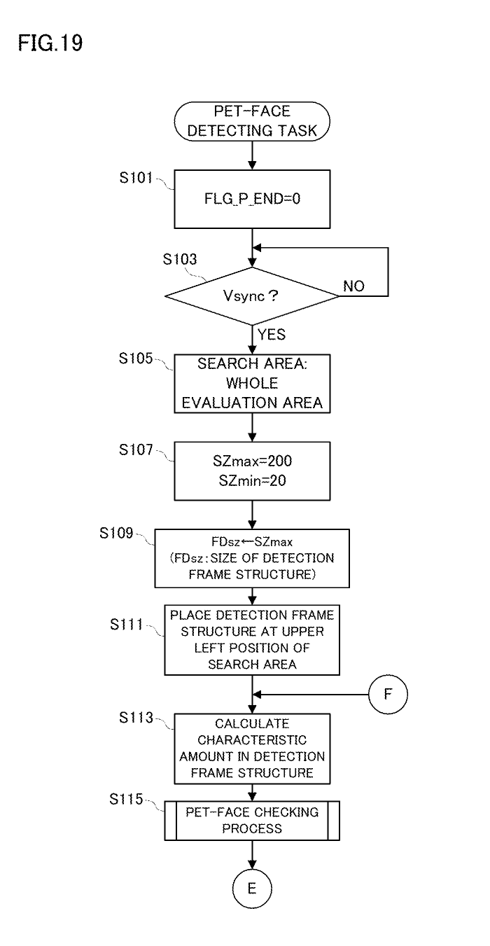

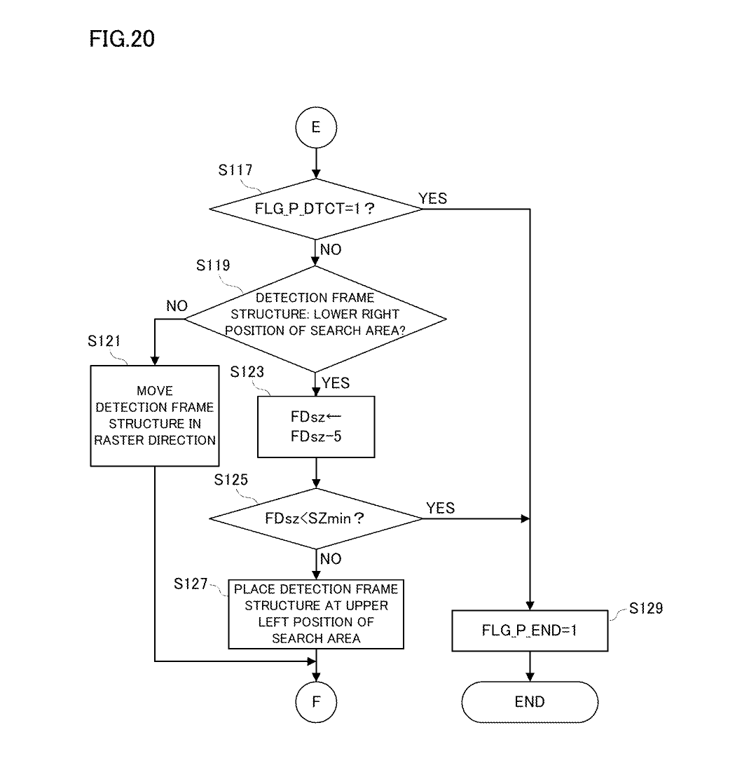

When a pet imaging mode is selected, the CPU 26 executes a plurality of tasks including the pet imaging task shown in FIG. 14 and FIG. 15, the person-face detecting task shown in FIG. 16 and FIG. 17 and the pet-face detecting task shown in FIG. 19 and FIG. 20, in a parallel manner. Control programs corresponding to these tasks are stored in a flash memory 44.

With reference to FIG. 14, in a step 1, the moving-image taking process is executed. As a result, the live view image representing the scene is displayed on the LCD monitor 38. In a step S3, the person-face detecting task is started up.

The flag FLG_H_END is set to “0” as the initial setting under the started-up person-face detecting task. Here, the flag FLG_H_END is the flag for identifying whether or not the person-face detecting task is completed. “0” indicates the task being under execution while “1” indicates the task being completed. In a step S5, it is determined whether or not the flag FLG_H_END indicates “1”, and as long as a determined result is NO, the simple AE process is repeatedly executed in a step S7. The brightness of the live view image is adjusted approximately by the simple AE process.

Moreover, as described above, the variable HDIR indicates that the face image of the person is discovered when the value is other than “0”. When the determined result of the step S5 is updated from NO to YES, in a step S9, it is determined whether or not the variable HDIR indicates “0”. When a determined result is NO, the face image of the person is regarded as being discovered, and therefore, in a step S11, the face-frame-structure character display command corresponding to the position and size of the face-detection frame structure FD at the current time point is issued toward the graphic generator 46. As a result, the face-frame-structure character KF_H is displayed on the LCD monitor 38 in a manner to surround the face image of the person. When the determined result is YES, the face image of the person is regarded as being undiscovered, and therefore, the process advances to a step S13 without displaying the face-frame structure character KF_H.

In the step S13, the pet-face detecting task is started up. The flag FLG_P_END is set to “0” as the initial setting under the started-up pet-face detecting task. Here, the flag FLG_P_END is the flag for identifying whether or not the pet-face detecting task is completed. “0” indicates the task being under execution while “1” indicates the task being completed. In a step S15, it is determined whether or not the flag FLG_P_END indicates “1”, and as long as a determined result is NO, the simple AE process is repeatedly executed in a step S17. The brightness of the live view image is adjusted approximately by the simple AE process.

Moreover, the flag FLG_P_DTCT is set to “0” as the initial setting under the started-up pet-face detecting task, and is updated to “1” when the face image coincident with the characteristic amount of the face of the animal contained in the pet dictionary PDC is discovered. When the determined result of the step S15 is updated from NO to YES, in a step S19, it is determined whether or not the flag FLG_P_DTCT indicates “1”. When a determined result is YES, the face image of the animal is regarded as being discovered, and therefore, in a step S21, the face-frame-structure character display command corresponding to the position and size of the face-detection frame structure FD at the current time point is issued toward the graphic generator 46. As a result, the face-frame-structure character KF_P is displayed on the LCD monitor 38 in a manner to surround the face image of the animal. When the determined result is NO, the face image of the animal is regarded as being undiscovered, and therefore, the process advances to a step S31 without displaying the face-frame structure character KF_P and executing another process.

In steps S23 and S25, the AE process and the AF process in which the discovered face image of the animal is noticed are respectively executed. As a result of the AE process and the AF process, the brightness and a focus of the live view image are adjusted strictly. Upon completion of the AF process, in steps S27 and S29, the still-image taking process and the recording process are executed. One frame of the image data immediately after the AF process is completed is taken by the still-image taking process into the still-image area 32d. The taken one frame of the image data is read out from the still-image area 32d by the I/F 40 which is started up in association with the recording process, and is recorded on the recording medium 42 in a file format.

Upon completion of the recording process, the face-frame-structures KF_H and KF_P are hidden in a step S31, and thereafter, the process returns to the step S3.

With reference to FIG. 16, in a step S41, the flag FLG_H_END is set to “0”, and in a step S43, it is determined whether or not the vertical synchronization signal Vsync is generated. When a determined result is updated from NO to YES, in a step S45, the whole evaluation area EVA is set as the search area.

In a step S47, in order to define a variable range of the size of the face-detection frame structure FD, the maximum size SZmax is set to “200”, and the minimum size SZmin is set to “20”. In a step S49, the size of the face-detection frame structure FD is set to “SZmax”, and in a step S51, the face-detection frame structure FD is placed at an upper left position of the search area. In a step S53, the image data belonging to the face-detection frame structure FD is read out from the search image area 32c so as to calculate the characteristic amount of the read-out image data.

In a step S55, the comparing process which compares the calculated characteristic amount with the characteristic amount of the face of the person contained in the person dictionaries HDC_1 to HDC_3 is executed. Upon completion of the comparing process, in a step S57, it is determined whether or not the variable HDIR indicates “0”. When a determined result is NO, the process advances to a step S69 while when the determined result is YES, the process advances to a step S59.

In the step S59, it is determined whether or not the face-detection frame structure FD reaches a lower right position of the search area. When the determined result is NO, in a step S61, the face-detection frame structure FD is moved in a raster direction by a predetermined amount, and thereafter, the process returns to the step S53. When the determined result is YES, in a step S63, the size of the face-detection frame structure FD is reduced by “5”, and in a step S65, it is determined whether or not the size of the face-detection frame structure FD is equal to or less than “SZmin”. When a determined result of the step S65 is NO, in a step S67, the face-detection frame structure FD is placed at the upper left position of the search area, and thereafter, the process returns to the step S53. When the determined result of the step S65 is YES, the process advances to the step S69. In the step S69, the flag FLG_H_END is set to “1”, and thereafter, the process is ended.

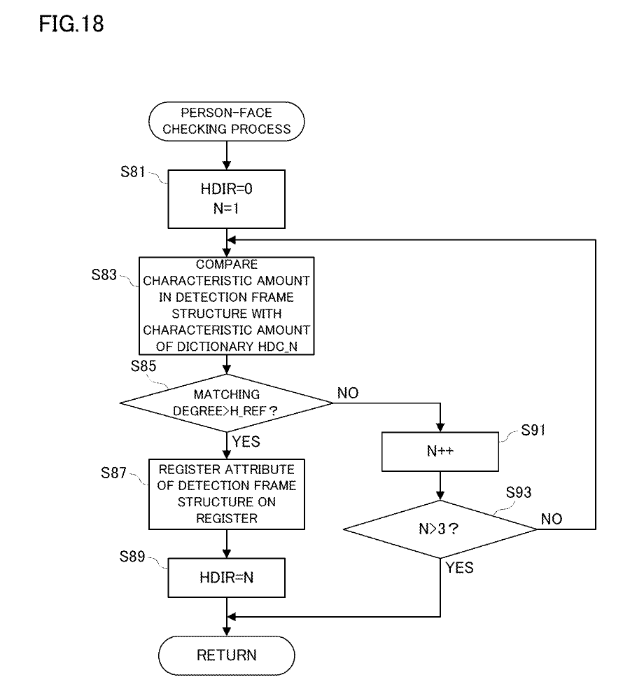

A person-face checking process in the step S55 shown in FIG. 16 is executed according to a subroutine shown in FIG. 18. Firstly, in a step S81, in order to declare that the posture of the person is indeterminate, the variable DIR is set to “0” and the variable N is set to “1”.

In a step S83, the characteristic amount of the image data belonging to the face-detection frame structure FD is compared with the characteristic amount contained in the person dictionary HDC_N, and in a step S85, it is determined whether or not the matching degree exceeds the reference value H_REF. When a determined result is NO, in a step S91, the variable N is incremented, and in a step S93, it is determined whether or not the incremented variable N exceeds “3”. When N≦3 is established, the process returns to the step S83 while when N>3 is established, the process returns to the routine in an upper hierarchy. When the determined result of the step S85 is YES, the face of the person is regarded as being discovered, and therefore, in a step S87, the current position and size of the face-detection frame structure FD is registered as the face-image information on the register RGSTH.

In a step S89, in order to hold the posture information of the discovered person, the variable HDIR is set to a value in which the variable N indicates at a current time point, and thereafter, the process returns to the routine in an upper hierarchy.

With reference to FIG. 19, in a step S101, the flag FLG_P_END is set to “0”, and in a step S103, it is determined whether or not the vertical synchronization signal Vsync is generated. When a determined result is updated from NO to YES, in a step S105, the whole evaluation area EVA is set as the search area.

In a step S107, in order to define the variable range of the size of the face-detection frame structure FD, the maximum size SZmax is set to “200”, and the minimum size SZmin is set to “20”. In a step S109, the size of the face-detection frame structure FD is set to “SZmax”, and in a step S111, the face-detection frame structure FD is placed at an upper left position of the search area. In a step S113, the image data belonging to the face-detection frame structure FD is read out from the search image area 32c so as to calculate the characteristic amount of the read-out image data.

In a step S115, the comparing process which compares the calculated characteristic amount with the characteristic amount of the face of the animal contained in the pet dictionary PDC is executed. Upon completion of the comparing process, in a step S117, it is determined whether or not the flag FLG_P_DTCT indicates “1”. When a determined result is YES, the process advances to a step S129 while when the determined result is NO, the process advances to a step S119.

In the step S 119, it is determined whether or not the face-detection frame structure FD reaches a lower right position of the search area. When the determined result is NO, in a step S121, the face-detection frame structure FD is moved in a raster direction by a predetermined amount, and thereafter, the process returns to the step S113. When the determined result is YES, in a step S123, the size of the face-detection frame structure FD is reduced by “5”, and in a step S125, it is determined whether or not the size of the face-detection frame structure FD is equal to or less than “SZmin” When a determined result of the step S125 is NO, in a step S127, the face-detection frame structure FD is placed at the upper left position of the search area, and thereafter, the process returns to the step S113. When the determined result of the step S125 is YES, the process advances to a step S129. In the step S129, the flag FLG_P_END is set to “1”, and thereafter, the process is ended.

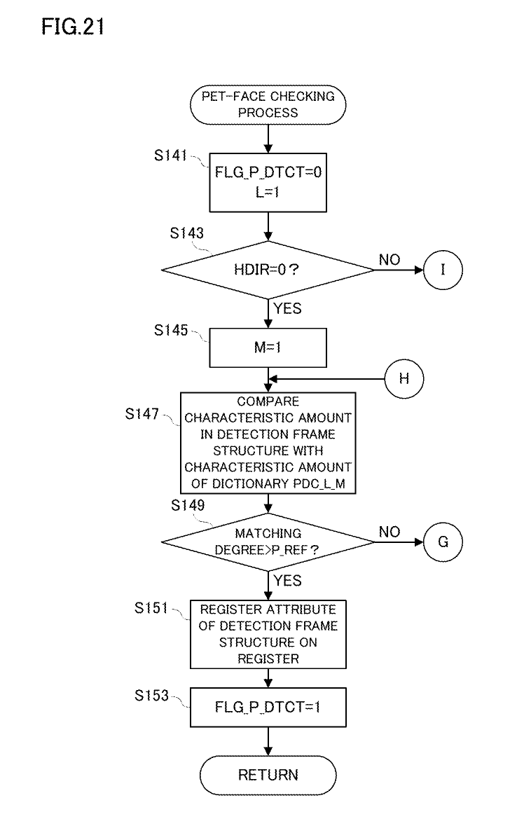

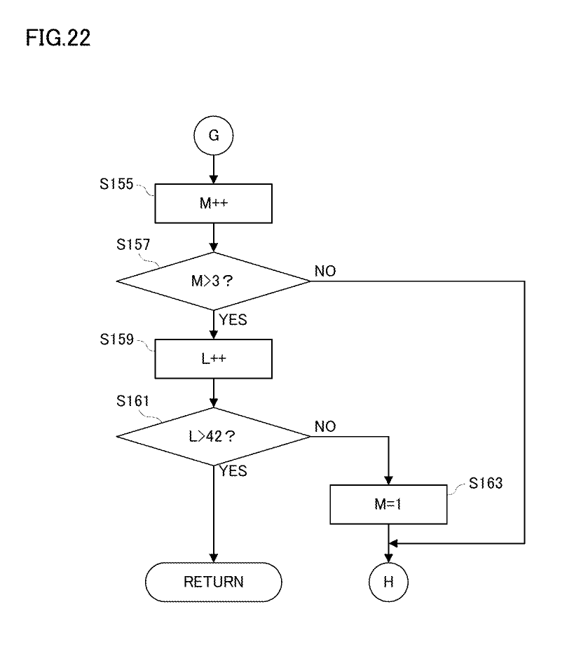

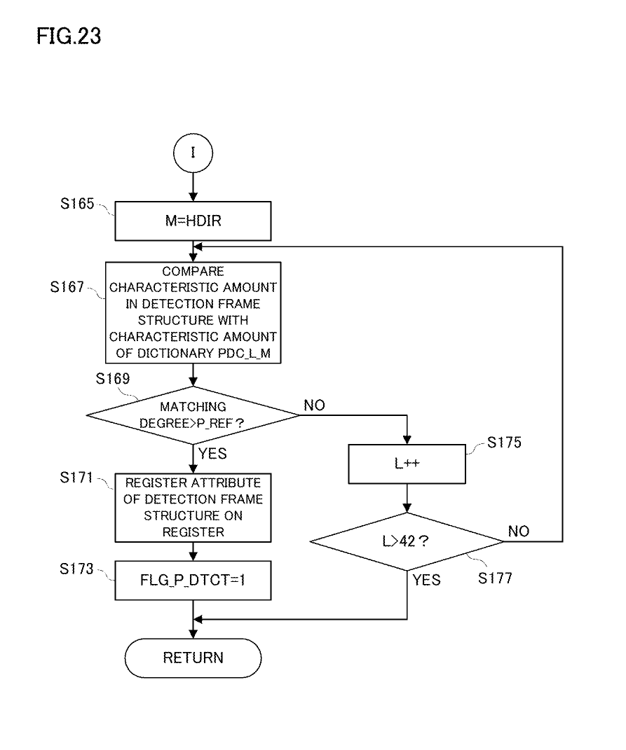

A pet-face checking process in the step S115 shown in FIG. 19 is executed according to a subroutine shown in FIG. 21 to FIG. 23. Firstly, in a step S141, in order to declare that the existence of the pet on the imaging surface is indeterminate, the flag FLG_P_DTCT is set to “0” and the variable L is set to “1”. In a step S143, it is determined whether or not the variable HDIR is “0”, and when a determined result is NO, the process advances to a step S165 while when the determined result is YES, the variable M is set to “1” in a step S145.

In a step S147, the characteristic amount of the image data belonging to the face-detection frame structure FD is compared with the characteristic amount contained in the pet dictionary PDC, and in a step S149, it is determined whether or not the matching degree exceeds the reference value P_REF. When the determined result is NO, the process advances to a step S155 while when the determined result is YES, the face of the animal is regarded as being discovered, and therefore, in a step S151, the current position and size of the face-detection frame structure FD is registered as the face-image information on the register RGSTP. In a step S153, in order to declare that the face image of the animal is discovered, the flag FLG_P_DTCT is set to “1”, and thereafter, the process returns to the routine in an upper hierarchy.

In the step S155, the variable M is incremented, and in a step S157, it is determined whether or not the incremented variable M exceeds “3”. When M≦3 is established, the process returns to the step S147 while when M>3 is established, the process advances to a step S159.

In the step S159, the variable L is incremented, and in a step S161, it is determined whether or not the incremented variable L exceeds “42”. When L≦42 is established, the variable M is set to “1” in a step S163 and the process thereafter returns to the step S147 while when L>42 is established, the process returns to the routine in an upper hierarchy.

In a step S165, the variable M is set to a value in which the variable HDIR indicates at a current time point, and in a step S167, the characteristic amount of the image data belonging to the face-detection frame structure FD is compared with the characteristic amount contained in the pet dictionary PDC_L_M. In a step S169, it is determined whether or not the matching degree exceeds the reference value P_REF. When a determined result is NO, the process advances to a step S175 while when the determined result is YES, the face of the animal is regarded as being discovered, and therefore, in a step S171, the current position and size of the face-detection frame structure FD is registered as the face-image information on the register RGSTP. In a step S173, in order to declare that the face image of the animal is discovered, the flag FLG_P_DTCT is set to “1”, and thereafter, the process returns to the routine in an upper hierarchy.

In the step S175, the variable L is incremented, and in a step S177, it is determined whether or not the incremented variable L exceeds “42”. When L≦42 is established, the process returns to the step S167 while when L>42 is established, the process returns to the routine in an upper hierarchy.

As can be seen from the above-described explanation, the imager 16 repeatedly outputs the scene image generated on the imaging surface capturing the scene. The CPU 26 searches for the face image representing the face portion of the person from the scene image outputted from the imager 16 (S41 to S69), and designates an animal-face dictionary corresponding to the posture along the posture of the discovered face image from among a plurality of animal-face dictionaries respectively corresponding to the plurality of postures different from one another (S165). Moreover, the CPU 26 executes the process of searching for the face image representing the face portion of the animal from the scene image outputted from the imager 16 by referring to the designated animal-face dictionary (S101 to S129, S167 to S177) and the output process different depending on the search result for the face image representing the face portion of the animal (S19 to S31).

Thus, upon searching for the face image representing the face portion of the animal, out of the plurality of animal-face dictionaries respectively corresponding to the plurality of postures different from one another, an animal-face dictionary corresponding to the posture along the posture of the face image representing the face portion of the person is referred to. Thereby, the time period required for searching for the face image of the animal is shortened, and as a result, the imaging performance is improved.

It is noted that, in this embodiment, the characteristic amounts of 42 species of animal faces classified in three families are contained in the pet dictionary PDC. However, the number of the families and species corresponding to the pet dictionary may be others.

Moreover, in this embodiment, the characteristic amounts of the faces in three postures are contained in the person-face dictionary HDC and the pet dictionary PDC for each species. However, in addition to those, a characteristic amount having the oblique attributes etc. may be added in each posture.

Moreover, in this embodiment, a still camera which records a still-image is assumed, however, the present invention may be applied to a movie camera which records a moving-image.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which repeatedly outputs an image representing a scene captured on an imaging surface;
a first searcher which searches for a face image representing a face portion of a person from the image outputted from said imager;
a designator which designates an animal-face dictionary corresponding to a posture along a posture of the face image discovered by said first searcher from among a plurality of animal-face dictionaries respectively corresponding to a plurality of postures different from one another;
a second searcher which executes a process of searching for a face image representing a face portion of an animal from the image outputted from said imager by referring to the animal-face dictionary designated by said designator; and
a processor which executes an output process different depending on a search result of said second searcher.

2. An electronic camera according to claim 1, wherein said processor includes a taker which takes an image in which the face image discovered by said second searcher appears.

3. An electronic camera according to claim 1, wherein said processor includes an adjuster which adjusts an imaging condition by noticing the face image discovered by said second searcher.

4. An electronic camera according to claim 1, wherein said first searcher includes a creator which creates posture information indicating a posture of the face image, and said designator executes a designating process based on the posture information created by said creator.

5. An electronic camera according to claim 1, wherein the posture noticed by said designator is equivalent to a posture in a rotation direction of an axis orthogonal to said imaging surface.

6. A computer program embodied in a tangible medium, which is executed by a processor of an electronic camera provided with an imager which repeatedly outputs an image representing a scene captured by an imaging surface, comprising:
a first searching instruction to search for a face image representing a face portion of a person from the image outputted from said imager;
a designating instruction to designate an animal-face dictionary corresponding to a posture along a posture of the face image discovered by said first searching instruction from among a plurality of animal-face dictionaries respectively corresponding to a plurality of postures different from one another;
a second searching instruction to execute a process of searching for a face image representing a face portion of an animal from the image outputted from said imager by referring to the animal-face dictionary designated based on said designating instruction; and
a processing instruction to execute an output process different depending on a search result of said second searching instruction.

7. An imaging control method executed by an electronic camera provided with an imager which repeatedly outputs an image representing a scene captured on an imaging surface, the imaging control method comprising:
a first searching step of searching for a face image representing a face portion of a person from the image outputted from said imager;
a designating step of designating an animal-face dictionary corresponding to a posture along a posture of the face image discovered by said first searching step from among a plurality of animal-face dictionaries respectively corresponding to a plurality of postures different from one another;
a second searching step of executing a process of searching for a face image representing a face portion of an animal from the image outputted from said imager by referring to the animal-face dictionary designated by said designating step; and
a processing step of executing an output process different depending on a search result of said second searching step.
